(19) United States
(12) Patent Application Publication
(10) Pub. No.: US 2003/0034735 A1
(43) Pub. Date: Feb. 20, 2003

(54) Gas discharge lamp and method of its manufacture

(76) Inventors: Bernd Rausenberger, Aachen (DE); Norbert Braun, Aachen (DE); Wilhelm Albert Groen, Einighausen (NL); Albrecht Kraus, Kerkrade (NL); Bauke Jacob Roelevink, Roosendaal (NL); Jozef J.A. Vorachen, Amstenrade (NL)

Correspondence Address: U.S Philips Corporation, 580 White Plains Road, Tarrytown, NY, 10591, US

(21) Appl. No.: 10/163,102

(22) Filed: Jun. 5, 2002

(30) Foreign Application Priority Data
Jun. 9, 2001 (DE) 10128139.0

(51) Int. Cl. H01J 11/00

(52) U.S. Cl. 313/607

(57) ABSTRACT

The invention relates to a method of manufacturing a gas discharge lamp and to such a gas discharge lamp 100. A known gas discharge lamp 100 comprises a hollow glass body 120 filled with a gas, which gas is excited into generating light through the supply of energy, and at least one ceramic electrode 140a, 140b fastened to the hollow glass body for the capacitive coupling of energy into the gas inside the hollow glass body 120. It is an object of the invention to simplify the manufacture of the gas discharge lamp 100. This is achieved according to the invention in that the glass material from which the hollow glass body 120 is formed and the ceramic material 140a, 140b from which the ceramic electrode is formed are chosen such that their two thermal expansion coefficients correspond at least by approximation, and in that the glass tube is fastened to the ceramic electrode through direct fusion.

The invention relates to a method of manufacturing a gas discharge lamp as defined in the preamble of claim 1, and to such a gas discharge lamp as defined in the preamble of claim 4.

A method of manufacturing a gas discharge lamp as well as such a gas discharge lamp are known in principle, for example from U.S. Pat. No. 2,624,858. The gas discharge lamp 100′ disclosed therein is shown in FIG. 3. It comprises a hollow glass body 120, in particular a glass tube, filled with a gas, which gas is excited through the supply of energy into the generation of light. The two open ends of the glass tube 120 are closed off by dielectric electrodes 140a, 140b. The electrodes seal off the glass tube 120 in a gastight manner; this is achieved, for example, in that the dielectric electrodes are fused (by glazing) to the glass tube. The electrodes serve for the capacitive coupling of energy into the gas inside the glass tube.

The cited U.S. document was submitted to the U.S. patent authorities as early as 1948. It is assumed for the purpose of the present invention that the term “glazing” used at the time in the cited U.S. document is understood to relate to a glazing process in which the dielectric electrodes 140a, 140b are provided with a glass enamel, and that the glass tube 120 is fused, i.e. “glazed” to the glass enamel. That is to say that at the time a fusion medium in the form of glass enamel was necessary for achieving a connection between the glass tube and the dielectric electrodes.

Starting from this prior art, it is an object of the invention to develop a known method of manufacturing a gas discharge lamp and a known gas discharge lamp itself further such that the manufacture of the gas discharge lamp is simplified.

According to patent claim 1, this object is achieved in that the thermal expansion coefficient of the glass material from which the hollow glass body is formed is chosen such that it corresponds at least approximately to the thermal expansion coefficient of the ceramic material from which the ceramic electrode is formed, and in that the hollow glass body is connected to the ceramic body by direct fusion.

Advantageously, this joining process utilizes no connection medium of any kind, for example in the form of a glass enamel or a glass solder, between the glass material and the ceramic material. It is thus considerably simplified in comparison with known joining processes.

The method according to the invention differs also from the method disclosed in the application DE 10014407.1 not previously published in the same manner, which latter method provides the use of a glass solder as a connecting medium for connecting a glass tube to a ceramic tube in the manufacture of a gas discharge lamp.

It is an absolute precondition for the implementation of the direct fusion according to the invention, however, that the claimed, optimum agreement of the thermal expansion coefficients of the two materials to be fused together should be present. Only if this condition is fulfilled will the connection be durable and will it not burst or crack.

The connection arising from the method according to the invention is advantageously vacuumtight and very stable.

The object of the invention as mentioned above is furthermore achieved by means of the gas discharge lamp as claimed in claim 4. The advantages of this gas discharge lamp correspond to the advantages mentioned above in relation to the manufacturing method.

Further advantageous embodiments of the manufacturing method and of the gas discharge lamp are defined in the dependent claims.

Three Figures are provided with the description, in which

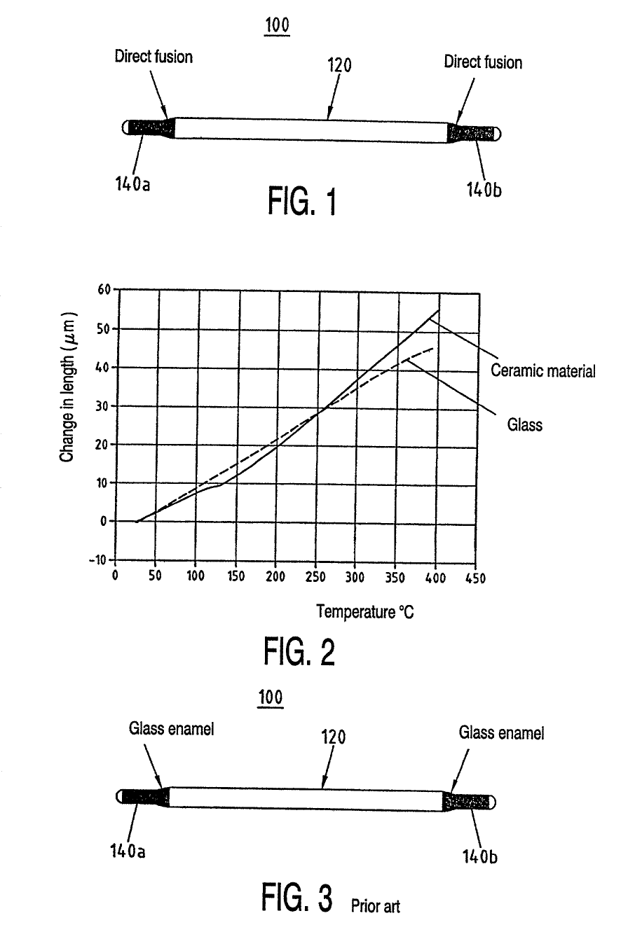

FIG. 1 shows a gas discharge lamp according to the invention;

FIG. 2 shows the gradient of the expansion of a glass material in comparison with the expansion of a ceramic material as a function of temperature; and

FIG. 3 shows a gas discharge lamp according to the prior art.

FIG. 1 shows a gas discharge lamp 100 according to the invention, comprising substantially the same components, indicated with the same reference numbers 120, 140a, 140b, as the gas discharge lamp 100′ described above with reference to FIG. 3.

The electrodes 140a and 140b are constructed as ceramic electrodes in the invention, preferably with dielectric material properties. The ceramic electrodes each comprise at least locally a conductive coating which serves as an electrically conducting contacting surface (not shown) for the application of a voltage.

In contrast to the gas discharge lamp 100′ shown in FIG. 3, the glass tube 120 and the two ceramic electrodes 140a, 140b are now joined together by direct fusion for sealing the glass tube 120 in the gas discharge lamp 100 according to the invention as shown in FIG. 1.

In the direct fusion method, first that location of the hollow glass body, for example an open end of the glass tube, where the hollow glass body is to be connected to the ceramic electrode is heated to approximately the glass melting temperature by means of a laser, a burner flame, or in a furnace. At the same time, the ceramic electrode is also heated to this same temperature. The melting temperature of the glass, however, lies far below the melting temperature of the ceramic material, so that in this process only the glass is melted, but not the ceramic material. The molten glass then runs over the ceramic electrode and fuses itself to the surface thereof. A gastight and highly robust connection is created in this manner, in particular after cooling down.

It is a precondition for the durability and robustness of this connection according to the invention, however, that only those glass and ceramic materials are chosen for the connection and are combined with one another whose thermal expansion coefficients correspond at least approximately.

FIG. 2 shows the expansion gradient of a glass material, soft sodium lime glass in this case, with the following composition in percents by weight: 68.1% SiO₂; 1.2% Li₂O; 3.0% SrO; 3.4% Al₂O₃; 8.7% BaO; 1.9% CaO; 7.3% Na₂O; 5.0% K₂O; and 1.3% MgO, in comparison with a ceramic material, BaTiO₃ in this case, with the following dopings in percents by weight: 1.6% Nb₂O₅; 1.6% CoO; and 1.6% Mn₂O₃, as a function of temperature. The two curves shown for the glass and ceramic materials mentioned lie close together over a relevant, wide temperature range of 0 to 350° C., even touching one another in certain locations. This means that the thermal expansion coefficients of the two materials lie sufficiently close together; as a result, the two materials are suitable for a connection by direct fusion. Bursting or cracking of the joint during or after cooling-down caused by internal mechanical stresses in the material is practically impossible.

1. A method of manufacturing a gas discharge lamp (100), which method comprises the step of connecting a hollow glass body (100), in particular a glass tube, to at least one ceramic electrode (140a, 140b) for the capacitive coupling of energy into the interior of the hollow glass body (120), characterized in that the thermal expansion coefficient of the glass material from which the hollow glass body is formed is chosen such that it corresponds at least approximately to the thermal expansion coefficient of the ceramic material from which the ceramic electrode is formed, and in that the hollow glass body is connected to the ceramic body by direct fusion.

2. A method as claimed in claim 1, characterized in that soft sodium-lime silicate glass is used as the glass material, and a material mainly formed of BaTiO₃ is used as the ceramic material.

3. A method as claimed in claim 2, characterized in that soft sodium lime glass is used as the glass material with a composition with the following percents by weight: 68.1% SiO₂; 1.2% Li₂O; 3.0% SrO; 3.4% Al₂O₃; 8.7% BaO; 1.9% CaO; 7.3% Na₂O; 5.0% K₂O; and 1.3% MgO; and in that BaTiO₃ is used as the ceramic material with the following dopants in percents by weight: 1.6% Nb₂O₅; 1.6% CoO; and 1.6% Mn₂O₃.

4. A gas discharge lamp (100) comprising
a hollow glass body (120), in particular a glass tube, filled with a gas, which gas is excited into generating light through the supply of energy; and
at least one ceramic electrode (140a, 140b) connected to the hollow glass body (120) for the capacitive coupling of energy into the gas inside the hollow glass body (120), characterized in that the thermal expansion coefficient of the glass material from which the hollow glass body (120) is formed is chosen such that it corresponds at least approximately to the thermal expansion coefficient of the ceramic material from which the ceramic electrode (140a, 140b) is formed, and in that the hollow glass body (120) is connected to the ceramic electrode (140a, 140b) by direct fusion.

5. A gas discharge lamp as claimed in claim 4, characterized in that the hollow glass body (120) is coated at least locally with a phosphor on its inner side.

6. A gas discharge lamp as claimed in claim 4, characterized in that the hollow glass body (120) is filled with a filling gas comprising at least a rare gas.

7. A gas discharge lamp as claimed in claim 4, characterized in that the hollow glass body (120) is filled with a filling gas which comprises mercury.
